(19) United States
(12) Patent Application Publication
(10) Pub. No.: US 2004/0157584 A1
(43) Pub. Date: Aug. 12, 2004

(54) Method for establishing and managing a trust model between a chip card and a radio terminal

(76) Inventors: Michael Bensimon, Grenoble (FR); Philippe Caloud, Saint-Ismier (FR); Cedric Pothin, Grenoble (FR); Nicolas Prunel, Grenoble (FR)

Correspondence Address: PERMAN & GREEN, 425 POST ROAD, FAIRFIELD, CT, 06824, US

(21) Appl. No.: 10/719,303

(22) Filed: Nov. 21, 2003

(30) Foreign Application Priority Data
Nov. 22, 2002 (FR) 02 14669

(51) Int. Cl. H04M 1/66; H04M 3/16

(52) U.S. Cl. 455/411; 455/558

(57) ABSTRACT

The method for establishing and managing a trust relationship between an identification module and a radio terminal comprises a terminal authentication step by said identification module done by using authentication means such as a key, said authentication means being provided to at least said identification module by a mobile radio-telephony network at the time of an initialization step or the like or at the time of a so-called updating.

In the method according to the invention, a key revocation step that can be carried out on the initiative of the identification module, the terminal, or the radio-telephony network comprises the erasure in a memory of said identification module of the key associated with the terminal.

The present invention relates to the field of mobile radio-telephony communications. The present invention relates more particularly to a method making it possible to establish a trust relationship between a radio-communication terminal and a SIM chip card or the like, in order to secure exchanges between the card and the terminal.

For the purposes of the following, a terminal is defined as any portative, portable transmitter-receiver device capable of operating on a mobile radio-telephony network such as GSM, GPRS, UMTS and any type of analog network such as WLAN, for example. The invention is intended for mobile telephones equipped with a chip cared such as a SIM chip card, for example, and relates especially to the distribution of secured contents for mobile telephones.

In the prior art, the problem of securing exchanges and data processing infrastructures has been approached for a long time. To date, a number of solutions have been proposed that are based on known cryptographic technologies. The management infrastructure for public keys (PKI for “Public Key Infrastructure”), in particular, is the solution based on asymmetrical key technologies (public Kp, private Kp), which is the most developed. A public key Kp having a sequence of digits used for encrypting or decrypting a message transmitted between a sender and a receiver is associated with a paired secret key, also called a private key Ks. Accordingly, the message can be encrypted by a public key known to a group of users and decrypted using a secret key known to the sole receiver or inversely encoded by a private key Ks and decrypted by the public key. While the encryption by the public key Kp assures the confidentiality of the message, the encryption by the private key Ks assures its integrity.

This solution is based on the notion that the initialization of a secured exchange or access to secured content is based on the use of public encrypting keys Kp that guarantee that only the holder of the associated private key Ks can decrypt the message and certificates associating in secured fashion the identification of the partner with the public key Kp, because it is certified (encrypted using a private key Ks) by certification authority AUC (acronym for “authentication center”).

The authentication center AUS assures in known fashion the authentication of subscribers and participates in the confidentiality of the data passing through the radio interface between the mobile terminal and the base station to which it is connected at any given time.

Nevertheless, the aforementioned solution is not entirely secured. Accordingly, the initialization of the authentication process is a weak point, because there are a number of certification authorities, whose certification policies do not necessarily have the same level of security. The average user does not know this and does not know, for example, that it could be very risky to accept certificates certified by certain authorities.

In addition, storage of the private keys Ks has been shown to be problematic, especially in the case, wherein it may be of interest to the user to know this key in order to have access to protected content. The protection of content against pirating must be, in fact, adapted in the case, wherein the “attacker” is not from the outside, but is typically the user himself. The existing solutions do not take this possibility into account.

Because of security failures, a revocation policy of mobile terminals is provided in prior art but this is difficult to implement in practice.

Also known in the prior art is the access to protected content by access rights using DRM (“Digital Rights Management”) for example. The general principle of DRM consists in providing a user with an encrypted content as well as a user's license. This license comprises user rights as well as an associated key making it possible to decrypt the content. In order that this associated key, generally symmetrical, is unavailable to the user, the license is either sent over a channel that makes it possible to “block” the user from reading the associated key as well as transmitting the license or the associated key is encrypted. The DRM solutions currently proposed are based on the use of a symmetrical key or a dual symmetrical key hard coded in the terminal. This other key makes it possible to encrypt said key associated with the license or to generate one or several said diversified keys for encrypting of the key associated with the license. Mechanisms are implemented at the level of the terminal in order to assure that said license decrypting key, identical to the key contained in the license itself, could be known by the terminal but not by the user.

In present day solutions for protecting content, the IMEI (“International Mobile Equipment Identity”) identity code proper to the mobile terminal is used in establishing a trust model between on the one hand the SIM or USIM (for networks commonly known as third generation) card and on the other hand the mobile terminal. In theory, the mobile terminal has a unique IMEI code and the majority of the methods planned consist of informing the SIM card of an IMEI code, with which the (U)SIM card can have a trust relationship.

A major drawback of these methods is that the IMEI code is not a secret number. It is easy, for example, from a PC with a chip card reader to send the IMEI trust code to the (U)SIM card and thus to create a trust model between a PC and a (U)SIM card. In addition, in main current mobile telephones the IMEI code can be easily changed. Thus, it is also possible to modify the IMEI of a mobile terminal that is not a priori trusted in order to replace it with the value of a trust IMEI.

As a result, the rights to use a secured content are thus associated with a mobile terminal and not with an individual. In order to be able to associate the user rights with a user, it is necessary to better know the security means between the SIM card and the terminal insofar that the terminal is not protected against manipulations and insofar as it cannot be authenticated by the (U)SIM card or other means difficult to subvert.

Furthermore, in the DRM type technologies, if a key pair such as said key pair is denied or expires, then the terminal can no longer be used, no re-initialization method being provided. In addition, any denial of the key pair makes necessary a very hypothetical detection of the protected content which would be provided to the terminal and which would be unprotected, for example on the Internet.

An object of the present invention is, therefore, to provide and manage a trust model between a radio-communication terminal and a SIM chip card or the like.

An object of the present invention is to eliminate one or several of the drawbacks of the prior art by defining a process making it possible to secure the exchanges between a SIM card and a terminal, wherein the operator of a mobile radio-telephony network replaces the certification authorities, this process making it possible to create a secured and irrevocable relation between the SIM or the USIM card and a terminal functionally authenticated by the network, this process also making it possible for the DRM type technologies to store said key pair securely in the SIM or the USIM card.

For this purpose, the invention relates to a method for establishing and managing a trust model between an identification module and a radio terminal, characterized in that it comprises:

a terminal authentication step by said identification module, said authentication step being carried out by means of authentication means provided either to said identification module by a mobile radio-telephony network at the time of a so-called initialization step or the like or at the time of a so-called updating step, or to said terminal by the identification module;

a control step by said module of at least one specific characteristic of the terminal, said specific characteristic being previously transmitted by radio-telephony to said module, from a secured server of said mobile radio-telephony network.

According to another feature of the invention, the lifetime of said terminal authentication means present in the identification module is limited by a determined expiration date, said authentication means being comprised of at least one authentication key.

According to another feature of the invention, said identification module is an SIM or USIM chip card for third generation networks or an equivalent card containing the representative subscriber data in a memory.

According to another feature of the invention, the identification module maintains a trust relationship with the radio terminal by generating authentication means and then by providing these authentication means to the radio terminal by secured exchange mechanisms based on initially available authentication means of the terminal.

Thus the invention makes it possible to make available security functions and secured storage for data in an SIM or USIM card and the establishment of a trust module between the terminal and this card. The different actors in the telecommunication field have an increasing tendency to favor the relation between a mobile terminal and the (U)SIM card so that said card provides it with security functions. These functions can be encryption functions, electronic wallet or even data access and storage functions.

According to another feature, the method according to the invention comprises at the time of said initialization or updating step a generation step, carried out by at least said identification module, of a so-called trust key, said trust key being utilized by said module for encrypting at least data exchanged between the identification module and the terminal.

According to another feature of the invention, said initialization step of the authentication means is done, on the initiative of the radio-telephony network, after denial of the key initiated by said module or by the mobile radio-telephony network or by the radio terminal, an expiration of the validity period of the key or even at the time of initialization of the identification module.

According to another feature, said authentication step comprises, in particular, the following steps:

an utilization step in the terminal of at least one first authentication key memorized in the terminal by at least one first authentication algorithm memorized in the terminal, said first key having a validity period limited by a predefined expiration date;

an utilization step by the identification module of at least one second key memorized in the identification module by at least one second authentication algorithm memorized in the identification module, said second key being identical or complementary to the first key and associated with the terminal, said second key having a validity period limited by said predefined expiration date;

a comparison step in the identification module for comparing the results obtained by said first and second algorithms.

According to another feature, authentication step comprises the utilization of said predefined expiration date.

According to another feature, said initialization step is initiated by a mobile radio-telephony network and also comprises:

generation by an identification module of at least one of said first and second keys;

a storage in the identification module of said second key;

transmission to the terminal by the identification module of said first key, said first key being encrypted by use of the trust key.

According to another feature, said comparison step is done between, on the one hand, a response produced by said first algorithm, stored in memory in the terminal and transmitted to said identification module and, on the other hand, a response result, stored in memory in the identification module, produced by said second algorithm.

According to another feature, said first key can be an asymmetrical private key Ks; said second key being a public key Kp complementary to the first key.

According to another feature, said first key can be symmetrical, said second key stored in memory in the identification module being identical to the first key, these keys forming a single symmetrical authentication key.

According to another feature, the method according to the invention comprises an updating step of said first and second keys, initiated by the identification module prior to said predefined expiration, said updating step including the following sub-steps:

authentication between the terminal and the identification module by means of said first and second keys;

generation by an updating algorithm of the identification module of at least one updated key taking into account an information for replacing at least one of said first and second keys;

memorization in the identification module of the updated key for replacing said second key;

transmission to the terminal by the identification module of the updated key analogue of said first key.

According to another feature, said updating step comprises in addition the control of at least one identifier of the terminal and/or of the identification module.

According to another feature, an encryption of the key is carried out for said transmission to the terminal of the updated key analogue of the first key, said key encryption being done by said trust key.

According to another feature, the updating step also comprises the following steps:

generation by the identification module of a new trust key, after said authentication between terminal and module:

memorization in the identification module of the new trust key;

transmission to the terminal by the identification module of the newly generated trust key.

According to another feature, said updating step is completed by a verification test comprising a return transmission on the part of the terminal of at least one datum representative of the effective receipt of data transmitted by the identification module during the updating step.

According to another feature, said trust key is a symmetrical encryption/decryption key analogous or identical to said symmetrical authentication key.

According to another feature, said trust key is an erasable session key.

According to another feature, a so-called revocation step is carried out on the initiative of the identification module of the terminal or of the corresponding radio-telephony network, said revocation step comprising the erasure in a memory of said identification module of at least said first key associated with the terminal.

A further purpose of the invention is to provide a solution to one or more problems encountered in the prior art by defining an identification module for the implementation of the method according to the invention.

This purpose is achieved by an identification module in a terminal for the implementation of the method of the invention, characterized in that it comprises means for memorizing at least one authentication key as well as at least one authentication algorithm, calculating means for executing at least one step consisting of applying said authentication key to said authentication algorithm memorized in the identification module, communication means, means for initiating a revocation and revocation means for revoking said authentication key, means for memorizing a specific characteristic of the terminal and means for actuating an updating algorithm for updating said authentication key, the communication means being capable of providing at least one authentication key to the terminal and of receiving data sent by a secured server of a mobile radio-telephony network.

The invention, together with its features and advantages, will become more apparent upon reading the description with reference to the appended drawings that are provided by way of non-limiting example, wherein:

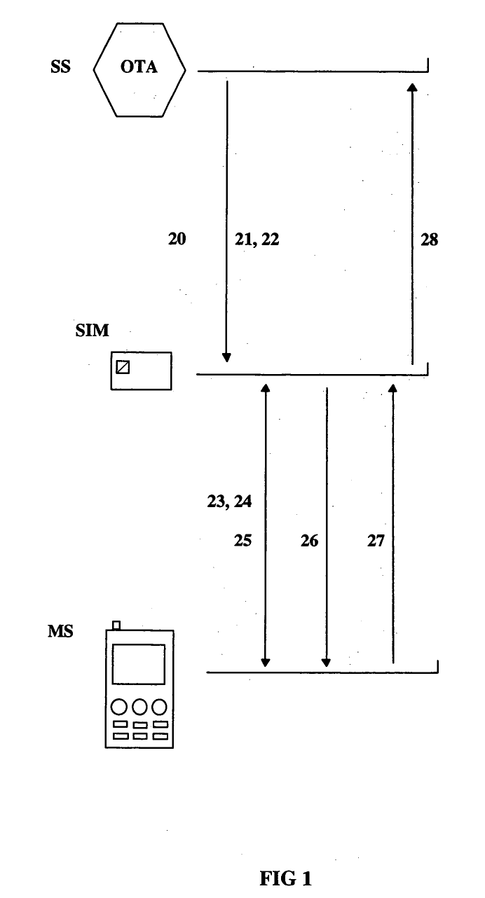

FIG. 1 diagrammatically represents the initialization process implemented in the invention;

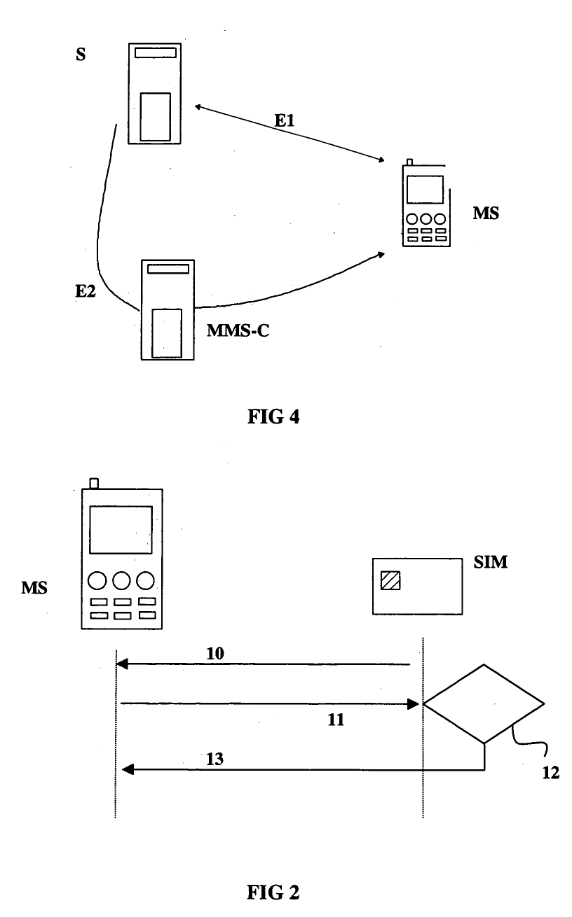

FIG. 2 diagrammatically represents an authentication of the terminal in the identification module in the method according to the invention;

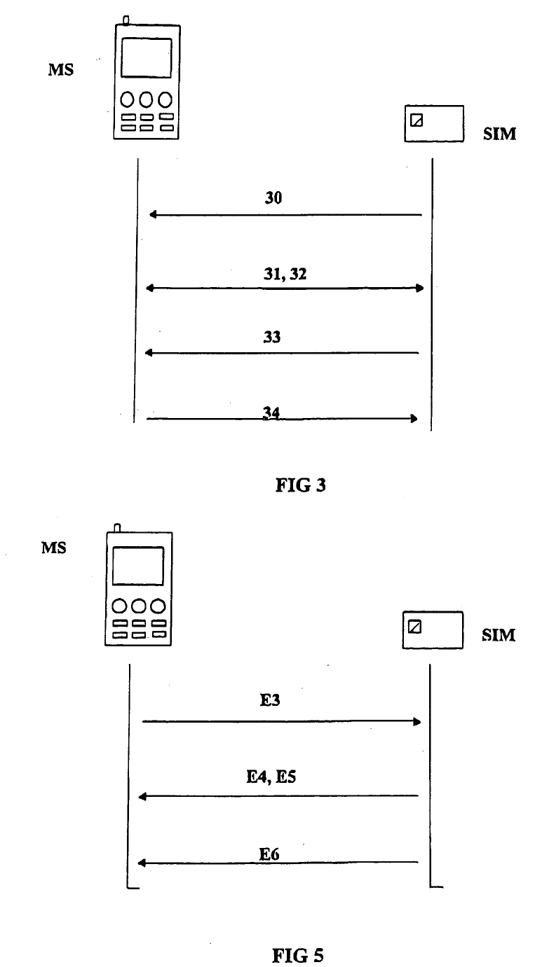

FIG. 3 represents an example of the method implemented in the invention for updating a key shared by the terminal and the identification module;

FIG. 4 diagrammatically represents the operating principle of used for DRM type technologies in prior art;

FIG. 5 represents an example of the problem encountered in prior art in the case of DRM when there is no trust module between the terminal and the SIM card.

Specifically, in the field of mobile telephony, three elements come into play. A first element, the terminal (MS), realizes the functions of access, storing and communication of secured data. A second element, the identification module (SIM), makes it possible to identify the user and makes it possible to store confidential information. Finally, a third element, the network, can communicate in secured fashion via a terminal (MS) with the identification module (MS). In one embodiment of the invention, the identification module (SIM) is a chip card such as SIM, USIM card, for example, for third generation networks or similar type networks, comprising in a memory representative subscriber data, a microprocessor and an operating program carrying out the specific functions below.

The identification module (SIM) may comprise communication means that make it possible for it to communicate simultaneously with the terminal and with a secured server (SS) of the network. In one variant, the terminal (MS) used may be so constructed as to behave transparently when it receives a specific secured command packet-type message sent from the secured server (SS) having as destination the identification module (SIM). For example, the secured server (SS) can send an SMS with an address specifying as its destination the module (SIM), by means of pointer means. A destination field can be provided for showing if the message should be received by the terminal (MS) or by the module (SIM).

FIG. 4 represents an example of the principle currently used for DRM (“Digital Rights Management”) technology. Access to a secured content is submitted firstly to the expression of the user rights defined by the authorized person and secondly to obtain the decryption key of the content. As represented in FIG. 4, an encrypted content is in a first step distributed, by means of a downloading operation (E1) between a content server (S) and the mobile terminal (MS). Then, in a second step, the necessary associated license for being able to utilize the content is sent (E2) to the terminal (MS) with a lock called a “forward lock”, via an MMS-C (“Multimedia Messaging Services Center”). The license contains the user rights and the symmetrical decryption key for the content. In compliance with the technologies and the standards, this license can be delivered to the terminal together with or separately from the content. In the mobile telephony field, the terminal (MS) authentication means continue to be weak and the solutions for protecting the license, nonexistent. Accordingly, the encryption key is not protected and the attacks on the content are thus facilitated. Likewise, one of the approaches of the OMA forum, represented in FIG. 4, consists of providing the decrypted code to the mobile terminal (MS) during the sending step of the license (E2). This approach is, for example, that of WAP DOWNLOAD, wherein the content is sent via a first channel and the license (E2) is sent via another channel, MMS for example, in theory by preventing the transfer of the key to other terminals. This channel makes it possible in principle to “block” the user from reading the key as well as transmitting the license. This type of process presents, in particular, the following drawbacks:

the key contained in the license is stored permanently and in decrypted code in the terminal (MS);

the license is bound to the terminal (MS) and not to the user;

the protection can easily be cracked, for example using a PC equipped with a GSM/GPRS modem.

Another approach consists of providing the symmetrical key encrypted by means of a key sorted hard coded and not known by the user in the mobile terminal (MS). However, in this second approach, the license remains linked to the terminal (MS) that can be modified by a hacker. Furthermore, it is almost impossible to control the integrity of the key and a revocation cannot be undertaken without rendering the mobile terminal (MS) un usable.

The method according to the invention makes it possible to secure exchanges of data between an identification module (SIM) such as a SIM or USIM card, for example, and a terminal (MS). In order to do this, a step of authentication of the terminal by said identification module (SIM) is carried out in such a fashion as to verify that the terminal (MS) used is in fact a trust terminal. The terminal (MS) must be able to identify itself with the identification module (SIM) by means of a symmetrical or asymmetrical key. If a symmetrical key is used, it must be stored at the same time in a memory of the terminal and in a memory of the identification module (SIM). If asymmetrical keys are used, that is, at least one public key Kp and at least one associated private key Ks, only the private key Ks must be stored in the terminal. The public key Kp is memorized in a memory of the identification module (SIM). According to a variant of the embodiment using asymmetrical keys, the authorization between the identification module (SIM) and the terminal (MS) is done by means of a public key Kp stored in a memory of the identification module (SIM) and an associated private key Ks stored in a memory of the terminal (MS). The asymmetrical public key Kp and the asymmetrical private key Ks are complementary. This authentication mechanism can also be used for the entire first authentication (23) done at the time of initialization. In the alternative, the public key Kp and the private key Ks are replaced for the first authentication by a symmetrical key.

In one embodiment of the invention, the keys or analogous authentication means are provided at least to the identification module (SIM) by transmission over a mobile radio-telephony network at the time of an initialization step or an updating step. The transmission of such authentication means is done on the initiative of the network under secured conditions, wherein the communication systems are considered as trust systems, for example, in communication with a secured OTA (“Over The Air”) server (SS). As shown in FIG. 1, one or a plurality of authentication keys can eventually be transmitted (21) to the identification module (SIM) at the time of a key initialization request (20) on the initiative of the secured OTA server (SS). At least one authentication key can, for example, correspond to a key already present in the terminal (MS). At least one terminal (MS) characteristic, for example the IMEI code or even the theoretical maximum output from the terminal, is also transmitted (22) to the identification module (SIM) by the OTA server (SS). A so-called first terminal (MS) authentication step by tho identification module (SIM) is done by means of the terminal (MS) authentication key. This first authentication step (23) is accompanied by a control (24) of the terminal (MS) characteristic(s), for example, the IMEI code, done by the module (SIM). This enables the module (SIM) to assure that the terminal (MS) is a trust terminal. The identification module (SIM) should, in fact, provide a decryption key or similar only to the terminals (MS) in which it has trust. In another variant embodiment, initialization can be effected without using the initialization key(s).

In order to make possible this transmission of authentication means, the identification module (SIM) must be of the “proactive” type, in other words, equipped with means for sending commands to the terminal (MS) so that it executes them. Otherwise, a “pulling” mechanism can be implemented, in other words, the terminal (MS) will periodically query the identification module (SIM) in order to assure that the module (SIM) has nothing to transmit to it.

A so-called trust key, for example, that can be cleared and functioning as a session key is generated (25) from a key generation algorithm of the module (SIM). This trust key is destined for the terminal (MS) and the identification module (SIM) for the purpose of encrypting the data exchanged between the identification module (SIM) and the terminal (MS). This trust key is stored in memory both in the identification module (SIM) and in the terminal (MS). At the time of key(s) updating requests, the identification module (SIM) generates at least one new authentication key for the next authentications between the terminal (MS) and the identification module (SIM). In the case of an asymmetrical key, after having stored the public key Kp in one of its memories, the identification module (SIM) transmits (26) the associated private key Ks to the terminal. This transmission (26) is secured insofar as the new private key Ks is encrypted using the trust key. In a variant of this embodiment, said trust key can be an symmetrical encryption/decryption key. For the instance, wherein a symmetrical authentication key is generated, the trust key can be, for example, analogous or identical to the symmetrical key being used in the authentication. In one embodiment of the invention, when the terminal (MS) has responded to an authentication criterion (23), control criterion (24) or to these two criteria (23, 24) and has then affirmatively received in a memory the transmitted key(s), it can send, for example, to the identification module (SIM), an acknowledgement message (27). Then, in similar fashion, the identification module (SIM) sends an acknowledgement message (28) to the OTA server (SS) of the network.

Thus, as shown in FIG. 1, the network can send a message (20) to the identification module (SIM) by providing it (21) with an initialization key, for example a symmetrical key, allowing it then to authenticate the terminal (MS) and/or to encrypt the exchanges with the terminal (MS). The identification module (SIM) can then initialize the transfer of a new key by utilizing this initialization key (23) for authenticating the terminal (MS) and/or the identification module (SIM) or even for encrypting the exchanges. This initialization can also pass through the control of any characteristics of the terminal (MS), such as initialization keys and initialization certificates present in the terminal (MS). Further, the characteristics of the terminal (MS) that can be verified by the network, for example, the IMEI or the maximum output of the terminal, can also be transmitted to the module (SIM) so that said module can do a supplementary control on the terminal (MS).

Re-initialization, reactivation steps, identical or similar to the initialization step can obviously be done in the method according to the invention. In one embodiment of the invention, said initialization step can be done after a key denial, an expiration of the validity period of the key or at the time of initialization of the identification module in the factory, for example.

In particular, the authentication step can consist, firstly, of a symmetrical or asymmetrical authentication key stored in the terminal (MS) to apply to one or a plurality of algorithms stored in the terminal (MS). In the same fashion, in the identification module (SIM), the associated key, symmetrical or asymmetrical, stored in the module (SIM) can be applled to one or a plurality of algorithms stored in said module (SIM). The response generated in the terminal (MS) is, for example, stored in the terminal and then transmitted (11) to the identification module (SIM), as shown in FIG. 2. This response is compared (12) to the one produced in the module (SIM). If the responses correspond, then the terminal (MS) has passed a first test indicating that it can eventually be considered as a trust terminal. If the control (24) of a specific characteristic such as the IMEI, for example, also confirms that the terminal is affirmatively the one to which it should give “trust”, exchanges of data (13) can be effected, for example exchanges of content accessible only by subscription and transmitted via the radio network. In the example of FIG. 2, the authentication step can be initiated by a request (10) from the identification module (SIM). In other embodiments, the authentication can be initiated by the terminal (MS).

As the terminals (MS) are not designed to resist attacks over time, the lifetime of a key is preferably limited. A comparison procedure to compare if the limit date of a key's validity to the current date is carried out in the module (SIM) as in the terminal (MS) in order to make it possible, if required, to trigger an updating. In one embodiment of the invention, the lifetime of the keys stored in the terminal (MS) and the identification module (SIM) is relatively brief, limited by a predefined expiration that is synonymous with the end of validity. An updating mechanism of these keys, for example at regular intervals, makes it possible to avoid problems associated with protection of the terminals (MS) over the duration.

The invention will now be described in connection with FIGS. 3 and 5.

The principle of updating consists of taking advantage of the co-localization of the identification module (SIM) and the terminal (MS). Firstly, let's consider that the identification module (SIM) and the terminal (MS) have a common symmetrical key that makes it possible for them to authenticate each other. Prior to the end of validity of the key, the terminal (MS) initiates with the identification module (SIM), or vice-versa, an updating of this key. In the example of FIG. 3, the updating request (30) is initiated by the identification module (SIM). The identification module (SIM) is then in charge of generating the new key, the so-called updated key, of storing it and transmitting it to the terminal (MS). Generation of the updated key is done by an updating algorithm of said module (SIM) taking into account information, for example the date of validity of the old shared key. At the time of this updating, the terminal (MS) and eventually said module (SIM) authenticate themselves (31) by means of the old shared key. In one embodiment of the invention, storing in a memory of the identification module (SIM) of the updated key can be done by pure and simple replacement of the old key. A terminal (MS) and/or module (SIM) identifier, whether on the basis of a certificate or not, can be used at this phase for facilitating the administration of the system and authentication of the terminal (MS) and of the identification module (SIM). In addition, the exchange of the updated key (33) is done by encrypting the updated key. This encrypting can be based on the use of the shared key for encrypting of even by means of generation of a session key (32), done after said authentication between terminal (MS) and identification module (SIM). No exchange with the network is done at the time of this type of updating, the identification module playing the role of “certification body.”

In one embodiment of the invention, the generation of a so-called trust key, such as a session key or the like, is done in the identification module (SIM), the trust key then being stored in memory in said module (SIM). Said trust key is then transmitted to the terminal (MS) and memorized in the terminal (MS). In another variant, the key is generated at the same time in the terminal (MS) and in the module (SIM). The updating can be completed by a verification test comprising a return transmission on the part of the terminal (MS) of at least one of the data transmitted by the identification module (SIM) during the updating step, or even a representative datum of satisfactory reception of the information transmitted by the identification module (SIM). For example, when the terminal (SIM) has affirmatively received and memorized said updated key sent (33) from the identification module (SIM), it sends to the identification module (SIM) an acknowledgement message (34).

Securing makes it possible, by the method according to the invention, to resolve the problems encountered in cases such as in DRM technology. FIG. 4 diagrammatically represents the absence of securing at the time of exchange of content in the methods of the prior art, for example, between a mobile terminal and a SIM card. Firstly, the terminal (MS) controls (E3) simply the rules of use of the content held by the SIM card. Then the SIM card grants a permission (E4) to “play” the content and a decryption key transfer approval. Then the SIM card transmits the decryption key in decrypted code to the terminal (MS). In this type of method, the provision of the data theoretically not accessible by the user is opened to terminals such as PCs equipped with a chip card reader. In addition, if the exchanges are not encrypted, the utilization of a probe makes it possible also to gain insight into confidential data. The method according to the invention, with a real terminal (MS) authentication step by the identification module (SIM) and an encrypting of the exchanges, assures reliable security of the exchanges to avoid such failures.

In one embodiment of the invention, it is possible to revoke the key associated with the terminal (MS). The denial of the key can be done on the initiative of the identification module (SIM) or of the network, and possibly by the terminal (MS). The principle consists of denying the key in the identification module (SIM) that eventually informs, using a program stored in said module (SIM), the network and the terminal (MS) of said denial. The revocation comprises the clearing of at least the key to be denied associated with the terminal (MS) in a memory of said identification module (SIM). Accordingly, if the terminal (MS) wishes to deny the key, in the case, for example, wherein it detects that its OVERALL SURVIVAL has been updated, it informs the identification module (SIM) of this, which may inform the network by means of classical secured OTA mechanisms. If the network wishes to deny the key, in the case, for example, wherein it detects that characteristics of the terminal (MS) have changed, such as the IMEI or even the maximum theoretical output of the terminal (MS), the network informs the identification module (SIM) of this using classical secured OTA mechanisms. Then, the identification module (SIM) may inform the terminal (MS). If the identification module (SIM) wants to deny the key, it may inform the terminal (MS) of this fact and possible the network. An alternative could be clearing of the authentication key and encrypting in the terminal (MS) and/or the module (SIM). From this point on, the identification module (SIM) will no longer be able to authenticate the terminal (MS) and re-initialization will be necessary.

In one embodiment of the invention, the identification module comprises means for storing at least one authentication key, an encryption key as well as at least two algorithms. The module (SIM) can also have the means for storing the encryption key as well as the encryption algorithm using the terminal (MS). These means can be, for example, an EEPROM type, memory, a ROM type memory, or a combination of the two. The identification module (SIM) comprises also calculation means for executing at least one step consisting of applying said authentication key to the algorithm memorized in the identification module (SIM), and means for activating an updating algorithm of said authentication key. The identification module (SIM) comprises also means for initiating a revocation and revocation means for revoking the authentication key associated with the terminal (MS), means for storing in memory a specific characteristic of the terminal (MS) and means for activating an algorithm for updating the authentication key associated with the terminal (MS). The identification module (SIM) can, in addition, in one embodiment of the invention, correspond to a proactive chip card.

The revocation means can make possible either a procedure for clearing the memory location containing the authentication key, or positioning a bit associated with this location. In this latter case, the bit will be read systematically at each request for access to this location and according to its value, access will be authorized (valid key) or denied (revoked key).

After a denial, an expiration of the lifetime of the key, or at the time of initialization, the activation initiative of the keys is sent to the network. The network decides to initialize or to re-initialize the trust model when it deems that the terminal (MIS) is a trust terminal. The network sends a message to the identification module (SIM) by means of classical secured OTA mechanisms based, for example, on the mechanisms provided by the GSM 03.48 standard in order to indicate that said module (SIM) can exchange a key with the terminal (MS). The message can also be sent by the network to the two other entities (SIM, MS). The initialization or the reactivation can be realized without protection of the exchanges between the module (SIM) and the terminal (MS). But it can also be based on the utilization of an initialization key that would be present in the terminal (MS) and provided to the identification module (SIM) by a secured OTA mechanism.

In the invention, the number of keys that can be used is unlimited. Several keys can obviously be used and generated. It is thus possible to use a key for authenticating the terminal (MS) as well as a key for encrypting the exchanges, or one key per type of exchange to be encrypted. Likewise, the use of asymmetrical keys instead of symmetrical keys is possible.

One of the advantages of the method according to the invention is taking into account in a versatile and economical fashion the fundamental problem of authentication of the terminal vis-à-vis the identification module (SIM): at the start of the dialogue between the identification module (SIM) and the terminal (MS), the identification module (SIM) must have proof that the terminal is affirmatively the one it claims to be and that it affirmatively implements the expected mechanisms. Instead of basing itself on a static mechanism of certification of the terminal, the method described proposes a dynamic certification of the terminal utilizing the network as a dynamic, because it is functional, certification tool: if the terminal is affirmatively the one it claims to be it must be capable of passing a certain number of tests with success, in particular involving exchanges with the identification module (SIM) and under the control of this module (SIM). It would then be very difficult to create a simulator of the terminal in order to have access to the authentication/encrypting key of the secured environment, because it would require that this terminal correctly carry out all of the tested operations, which would be very difficult to do in practice.

Another advantage of the invention relative to existing techniques, is that even if it appears that certain non-secured terminals (MS) have cracked the aforementioned mechanism and make it possible for unauthorized third parties to access secured content, it is very easy to revoke these terminals (MS), because the identification module (SIM) remains the master component of the device and the network can send it an invalidation order at any time.

Another advantage of the invention resides in the coupling between the identification module (SIM) and the terminal (MS) that can be utilized for protecting the known and modifiable user data, for example, the “login” and the password to access to the user's bank, for storing data that the user should not be able to modify, for example, user rights to a software or music. This coupling can also be applied for the storage of data into which the user should not have insight, for example, storing a key enabling decrypting of music prior to its execution. The functions transmitted to the terminal (MS) by the identification module (SIM) can be cryptographic functions, electronic wallet functions, or even data storage and access functions.

The applications of the invention are numerous. Accordingly, in a DRM application, the SIM card can be used for storing user rights and any content decrypting keys. When terminal (MS) application needs one of its keys, it can query the terminal (MS) that will identify the application and that will authenticate it with the SIM card. From that point on, the SIM card granting trust to the terminal (MS), it can control the user rights of the keys per application and then transmit the required keys to the application. The transmission of the keys can then be encrypted by means of using a session key or by means of using a key provided for this purpose or even by means of using the encrypting key.

It will be obvious for persons skilled in the art that the present invention allows embodiments in many other specific forms while remaining within the scope of application of the invention as claimed. Consequently, the present embodiments are to be considered as illustrations but can be modified in the field defined by the scope of the enclosed claims, and the invention is not to be limited to the details given above.

1. A method for establishing and managing a trust model between an identification module and a radio terminal, characterized in that it comprises:
a terminal authentication step by said identification module, said identification step being carried out by means of identification means provided either to said identification module by a mobile radio-telephony network at the time of an initialization step or similar or at the time of a so-called updating step, or to said terminal by the identification module;
a control step by said module of at least one specific characteristic of the terminal, said specific characteristic being previously transmitted by radio-telephony to said module from a secured server of said mobile radio-telephony network.

2. The method according to claim 1, wherein the lifetime of said terminal authentication means present in the identification module is limited by a determined expiration date, said authentication means being comprised of at least one authentication key.

3. The method according to claim 1, wherein said identification module is an SIM type chip card or an USIM card for third-generation networks or an equivalent card comprising in a memory the representative subscription data.

4. The method according to claim 1, wherein the identification module maintains a trust relationship with the radio terminal by generating authentication means and then by providing these authentication means to the radio terminal by secured exchange mechanisms based on authentication means initially available from the radio terminal.

5. The method according to claim 1, comprising at the time of said initialization or updating step a generation step, carried out at least by said identification module, of a so-called trust key, said trust key being used by said module for encrypting at least data exchanged between the identification module and the terminal.

6. The method according to claim 2, wherein said initialization step of said authentication means is done on the initiative of the radio-telephony network, after denial of the key initiated by said module or the mobile radio-telephony network or the radio terminal, following an expiration of the validity period of the key or even at the time of initialization of the identification module.

7. The method according to claim 1, wherein said authentication step comprises especially the following steps:
an utilization step in the terminal of at least one first authentication key memorized in the terminal by at least on first authentication algorithm memorized in the terminal, said first key having a validity period limited by a predefined expiration date;
an utilization step by the identification module of utilization of at least one second key memorized in the identification module by at least one second authentication algorithm memorized in the identification module, said second key being identical or complementary to the first key and associated with the terminal, said second key having a validity period limited by said predefined expiration date;
a comparison step in the identification module for comparing the results obtained by said first and second algorithms.

8. The method according to claim 2, wherein the authentication step comprises the utilization of said predefined expiration date.

9. The method according to claim 7, wherein said initialization step is initiated by a mobile radio-telephony network and also comprises:
generation by the identification module of at least one of said first and second keys;
a storage in the identification module of said second key;
transmission to the terminal by the identification module of said first key, said first key being encrypted by use of the trust key.

10. The method according to of claim 7, wherein said comparison step is done between, on the one hand, a response produced by said first algorithm, stored in memory in the terminal and transmitted to said identification module and, on the other hand, a response result, stored in memory in the identification module, produced by said second algorithm.

11. The method according to claim 7, wherein said first key is an asymmetrical private key Ks and said second key being a public key Kp complementary to the first key.

12. The method according to claim 7, wherein said first key is symmetrical, said second key stored in memory in the identification module being identical to the first key, these keys forming a single symmetrical authentication key.

13. The method according to claim 7, comprising an updating step of said first and second keys, initiated by the identification module prior to said predefined expiration, said updating step including the following sub-steps:
authentication between the terminal and the identification module using said first and second keys;
generation by an updating algorithm of the identification module of at least one updated key taking into account an information for replacing at least one of said first and second keys;
memorization in the identification module of the updated key for replacing said second key;
transmission to the terminal by the identification module of the updated key analogue of said first key.

14. The method according to claim 13, wherein said updating step comprises in addition the control of at least one identifier of the terminal and/or of the identification module.

15. The method according to claim 13, wherein an encryption of the key is carried out for said transmission to the terminal of the updated key analogue of the first key, said key encryption being done by said trust key.

16. The method according to claim 13, wherein the updating step also comprises the following steps:
generation by the identification module of a new trust key after said authentication between terminal and module;
memorization in the identification module of the new trust key;
transmission to the terminal by the identification module of the newly generated trust key.

17. The method according to claim 13, wherein said updating step is completed by a verification test comprising a return transmission on the part of the terminal of at least one datum representative of effective receipt of data transmitted by the identification module during the updating step.

18. The method according to claim 5, wherein said trust key is a symmetrical encryption/decryption key analogous or identical to said symmetrical authentication key.

19. The method according to claim 5, wherein said trust key is an erasable session key.

20. The method according to claim 7, wherein a so-called revocation step is carried out on the initiative of the identification module, of the terminal, or of the corresponding radio-telephony network, said revocation step comprising the erasure in a memory of said identification module of at least said first key associated with the terminal.

21. An identification module in a terminal for the implementation of the method according to claim 1, characterized in that it comprises means for memorizing at least one authentication key as well as at least one authentication algorithm, calculation means for executing at least one step consisting of applying said authentication key to said authentication algorithm memorized in the identification module, communication means, means for initiating a revocation and revocation means for revoking said authentication key, means for memorizing a specific characteristic of the terminal and means for actuating an updating algorithm for updating said authentication key, the communication means being capable of providing at least one authentication key to the terminal and receiving data send from a secured server of a mobile radiotelephony network.
